(19) United States
(12) Patent Application Publication
(10) Pub. No.: US 2026/0076372 A1
(43) Pub. Date: Mar. 19, 2026

(54) SPRAYABLE ANTIFUNGAL COMPOSITION FOR USE IN THE FIELD OF AGRICULTURE, AND ASSOCIATED METHOD AND USE

(71) Applicant: GAIAGO, Saint-Malo (FR)

(72) Inventors: Aude BERNARDON MERY, Plouër-sur-Rance (FR); Francis BUCAILLE, Nevers (FR)

(21) Appl. No.: 18/997,579

(22) PCT Filed: Jul. 26, 2023
(86) PCT No.: PCT/FR2023/051169

§ 371 Date: Jan. 22, 2025

(30) Foreign Application Priority Data
Jul. 27, 2022 (FR) 2207712

(51) Int. Cl. A01N 59/16; A01N 31/08; A01N 43/90; A01N 59/06; A01N 59/20; A01N 63/32; A01N 65/40; A01P 3/00

(52) U.S. Cl. CPC A01N 59/16; A01N 31/08; A01N 43/90; A01N 59/06; A01N 59/20; A01N 63/32; A01N 65/40; A01P 3/00

(57) ABSTRACT

The present invention relates to an antifungal composition for use in the field of agriculture, which composition contains molybdenum ions, in particular molybdate. According to the invention, the composition contains, as the active ingredient, a combination of
at least one compound chosen from among resveratrol, smilagenin and hecogenin, and preferably the three aforementioned compounds, with
molybdenum ions/molybdate, and
at least one ion chosen from among iron, potassium, magnesium, copper and manganese ions, and preferably the five aforementioned ions.

### TECHNICAL FIELD

The present invention relates to an antifungal composition for use in agriculture which comprises compounds of natural origin as active agents.

### PRIOR ART

Pesticides are a major source of environmental pollution because they accumulate in soils and are diffused in groundwater tables. A large quantity of pesticides is used to treat particular crops such as grapevines, fruit trees, vegetables and other plants grown in intensive agriculture. This is also the case for industrial crops such as potatoes and cereals such as wheat, for example.

A good approach to reducing the quantity of plant protection products is, on one hand, that of targeting plant diseases for which the largest quantities of plant protection products are used.

On the other, it is recommended to use plant protection products which contain active ingredients of natural origin in order to reduce pollution caused by synthetic pesticides, the effects of which on living organisms and particularly humans is sometimes poorly known.

Research has commenced in this regard, the publication of which entitled “Comparative studies on the effects of a yucca extract and acibenzolar-S-methyl (ASM) on inhibition of Venturia inaequalis in apple leaves” published in the European Journal of Plant Pathology, Kluwer Academic Publishers, vol. 124, No. 2 (2008 Dec. 7) pages 187-198 describes the use of yucca extract against Venturia inaqualis on apple leaves.

Document WO 2007/139382 A1 describes a composition for controlling fungal foliar diseases in apple trees such as those caused by Venturia inaequalis and Podosphaera leucotricha. This document states that yucca extract and potassium bicarbonate were shown to be active (separately) on leaves at certain concentrations. The combination of yucca extract with sulphur was not shown to be active. Copper in copper hydroxide form is the most active agent on leaves and fruit.

Document WO 2020/188225 A1 describes a contact fungicide which comprises magnesium hydroxide in the form of particles of a given size and containing at least 86% magnesium hydroxide. Given that it consists of a contact fungicide, the direct contact between the fungicidal product and the fungus induces the death of the latter on account of the highly alkaline nature of magnesium hydroxide. Magnesium hydroxide is insoluble in water. Hence, it must be used in suspension form and often requires the addition of a surfactant to obtain a stable suspension.

The publication entitled “Effect of potassium and manganese phosphites in the control of Pythium damping-off in soybean: a feasible alternative to fungicide seed treatments” by M. A. Carmona published in the online journal Society of Chemical Industry on 9 Oct. 2017 relates to the use of phosphites. The phosphite ion HPO₃²⁻ is active unlike the metallic cation. Document RU 2 204 248 C1 describes a treatment for damage caused to fruit and trees. This damage includes scorching, wounds, grafting. The product described contains tripoli and a fungicide. The fungicide can be copper sulphate, iron sulphate or copper oxychloride (Cu(OH)₂). The product is intended for bark. Tripoli contains oxides such as iron oxide, aluminium oxide, calcium oxide, magnesium oxide, sodium oxide and potassium oxide. The product is not applied on leaves. Furthermore, this publication does not cite any fungal pathogen.

The publication entitled “Control of post-harvest decay of apples by pre-harvest application of ammonium molybdate” by C. Nunes published in Pest Management Science in 2001 (pages 1093-1099) (D7) describes the efficacy of ammonium molybdate against P. expansum, Botrytis cinerea and Rhizopus stolonifer on apples. This document indicates that other molybdenum salts were tested as spore germination inhibitors (namely potassium molybdate and sodium molybdate) but only ammonium molybdate is effective. We therefore infer therefrom that the ammonium ion is active and not the ion derived from molybdenum.

The publication entitled “Investigations on fungicides IX. The fungitoxicity, phytotoxicity and systemic fungicidal activity of some inorganic salts” by G. A. Carter published in 1964 Annals of Applied Biology (page 291-309) looks at fungal action against Botrytis fabae. Germination of the pathogen spores is studied. Potassium chromate is ecotoxic and exhibits no activity on A. solani on tomatoes. Sodium molybdate has a superior activity to sodium dichromate and it can be inferred therefrom that molybdate is weakly active on A. solani growth on seeds. Manganese chloride is not active, it is even phytotoxic on tomatoes. In this publication, the tomato plants studied were sprayed with solutions.

This document also states that yucca extract (pure extract of Y. schidigera) was used at 5% by volume in distilled water on apple leaves against Venturia inaequalis. Yucca extract acts as a fungicide by preventing or stopping penetration of this pathogen in apple trees.

It is also clearly established that the use of plant-derived products poses a composition reproducibility problem. Indeed, the composition of plants varies considerably according to the location where they grow, the season and the stage at which they are harvested to be used. The use of a given plant to manufacture an extract or an infusion does not make it possible to regularly obtain a product containing the active ingredients at their effective dose.

Moreover, the efficacy of a product is dependent on the pathogen but also on the plant treated. Thus, a composition can be effective against a given pathogen on tomatoes but be ineffective on the same pathogen in another plant.

It is furthermore observed that pathogens in which the life cycle involves soil are more difficult to control on low-foliage plants (vegetables for example) than on high-foliage plants (trees and shrubs) due to “splash effect” contaminations (by mud during rain, for example).

### Technical Problem to be Solved

One technical problem addressed by the present invention is that of providing an antifungal composition containing active ingredients of natural origin which can be produced readily according to reproducible and standardised processes to arrive at a composition wherein the active substance concentrations are identified, standardised and consistent agronomic results.

Another technical problem addressed by the present invention is that of providing an antifungal composition which is harmless for animals and in particular for mammals of which humans.

Another technical problem addressed by the present invention is that of providing an antifungal composition which is not phytotoxic.

Another technical problem addressed by the present invention is that of providing an antifungal composition in particular as cited above which is effective against at least one pathogen chosen from: Alternaria solani, Plasmopara viticola, Septoria tritici, Fusarium graminearum, Erysiphe necator. Pythium ultimum, Tilletia caries, Zymoseptoria tritici and Rhizoctonia solani.

Another technical problem addressed by the present invention is that of providing an antifungal composition in particular as cited above, which is effective for preventive and/or curative treatment on a plant chosen in particular from among the plants of the following families: Brassicaceae of which rapeseed, Fabaceae of which soybean, Vitaceae of which grapevine, Poaceae of which wheat, maize, Rosaceae of which apple and pear trees, Solanaceae of which potato, tomato, aubergine, Alliaceae of which onion, garlic, shallot and leeks, Apiaceae of which carrots, Asteraceae of which lettuce, artichoke, and sunflower, and Chenopodiaceae of which beetroot.

Another technical problem addressed by the present invention is that of providing an antifungal composition which is effective against at least one fungal pathogen and preferably effective against several pathogens, chosen from among: Alternaria solani, Septoria tritici, Plasmopara viticola, Fusarium graminearum and Erysiphe necator, Pythium ultimum, Tilletia caries, Zymoseptoria tritici and Rhizoctonia solani and in particular against A. solani in tomatoes and Plasmopara viticola in grapevine.

Another technical problem addressed by the present invention is that of providing an antifungal composition which is harmless for the environment and readily degradable.

Another technical problem addressed by the present invention is that of providing an antifungal composition for use in the field of agriculture which is multipurpose, i.e. effective against at least two fungal soil and/or foliar pathogens.

Another technical problem addressed by the present invention is that of providing a composition which can be diluted before use and which according to its dilution can be particularly effective against at least one given pathogen on at least two different plants.

### SUMMARY OF THE INVENTION

The present invention relates to an antifungal composition for use in the field of agriculture, which contains molybdenum ions, in particular molybdate and, as the active ingredient, a combination of at least one compound chosen from among resveratrol, smilagenin and hecogenin and preferably the aforementioned compounds with molybdenum ions/molybdate and at last one trace element chosen from among iron, potassium, magnesium, copper, manganese ions, and in particular a mixture of these 5 ions.

Advantageously, regardless of the embodiment, the composition contains resveratrol, more particularly trans-resveratrol.

Preferably, the composition contains resveratrol, smilagenin and hecogenin. These compounds are preferably contained in a yucca juice.

The composition can also contain resveratrol and hecogenin or resveratrol and smilagenin.

The inventors indeed have the merit of having demonstrated that these three compounds are effective, as antifungal agents and that their antifungal action could be increased by the user of at least one of the aforementioned ions. Yucca extracts which were known as antifungal agents contain many compounds of which saponins which were considered as active. However, many saponins can be harmful for human health. Smilagenin and hecogenin which are steroidal saponins are present only in small quantities in aqueous yucca extract. Therefore, it was not obvious that these particular saponins can have an antifungal effect at very low doses.

The publication by E. G. Wulff entitled “Yucca shidigera extract: a potential biofungicide against seedborne pathogens of sorghum” and published in Plant Pathology on 3 Aug. 2011 demonstrates that a synthetic mixture of saponins containing from 8 to 25% by mass of saponin proves to be less effective than an aqueous solution containing 10% by mass of yucca extract on sorghum seed pathogens. Therefore, not all saponins are effective as an antifungal. Moreover, resveratrol, smilagenin and hecogenin are known to be harmless for human health. Resveratrol is known for its antiinflammatory and antioxidant effects. Smilagenin is the subject of studies for its use in the treatment of orphan diseases, in particular neurological. Hecogenin is used to attenuate colitis or to treat atopic dermatitis and bronchial hyperreactivity.

The composition of the invention is therefore found to be effective as an antifungal and harmless for mammals, of which humans.

### DETAILED DESCRIPTION

Smilagenin, hecogenin and resveratrol can be extracted and purified from juice extracted from plants. Thus, resveratrol is present in fruit juice, particularly grape. Saponins are present in tea, chickpeas, climbing ivy leaves, soapwort, quinoa, fenugreek leaves, liquorice root, ginseng roots, horse chestnut cotyledons, great mullein leaves and dioscorea tubers, for example. It is therefore possible to use juices, infusions, extracts or decoctions of these plants optionally in a mixture to obtain the composition of the invention. Smilagenin, hecogenin and resveratrol can also be synthesised. It is thus easy to produce a standardised composition.

The aforementioned ions can be introduced in the form of salts, particularly sulphate, chloride, iodide, ammonide, hydrochloride, oxychloride, hydroxide, sulphonate, carbonate, formiate, acetate, gluconate, lactate, citrate and sodium and ammonium salts.

The antifungal composition of the invention can also comprise one or more chelating agents chosen from among EDTA, HEEDTA, DTPA, EDDHA, EDDHMA, EDDCHA, EDDHSA, IDHA, HBED, and/or at least one complexing agent chosen from lignosulphonic acid and ethanolamine. These agents increase the solubility of metal ions and thus stabilise the composition of the invention when it contains a solvent.

Thus, manganese, iron, magnesium, copper can be introduced preferably in the form of sulphates. Molybdate can be introduced preferably in the form of sodium molybdate. Potassium can be introduced preferably in the form of potassium chloride.

The composition of the invention can be liquid or viscous or in powder form. It can in this case consist of the aforementioned ingredients and in particular consist of a mixture of resveratrol, smilagenin, hecogenin and salts of the aforementioned ions. It can also be presented in the form of a suspension.

Advantageously, it contains a vehicle. The vehicle is not limited according to the invention. It is preferably water. The composition of the invention is preferably sprayable and/or capable of coating a solid. The composition can be a solution, a biphasic mixture, an emulsion or a micellar solution. It is advantageously an aqueous solution.

Advantageously, the composition contains a mass percentage of trans-resveratrol greater than or equal to 0.01 and/or a mass percentage of hecogenin greater than or equal to 0.00032 and/or a mass percentage of smilagenin greater than or equal to 0.004.

The composition can contain resveratrol and hecogenin or resveratrol and smilagenin. It can also contain the three compounds.

According to an embodiment that can be combined with each of the other embodiments, the composition contains the aforementioned ions with the exception of copper ion and/or manganese ion. According to a particular embodiment that can be combined with each of the other embodiments, the composition contains, as the trace element, molybdenum in molybdate form, magnesium and potassium.

According to a particular variant, some of the active compounds (smilagenin, hecogenin and resveratrol) are contained in yucca trunk juice and the composition therefore contains yucca trunk juice, which contains the three aforementioned compounds.

According to a variant that can be combined with each of the aforementioned embodiments or variants, in its diluted form, the composition of the invention contains a mass percentage of yucca trunk juice greater than or equal to 0.0012.

With regard to the hydration of the salts used, Table 19 compiles the main preferred degrees of hydration of the salts.

The composition of the invention can be present in two forms, a dilute form for use as is or a concentrated form to be diluted or dissolved before use.

In its concentrated form, according to particular embodiments, that can be combined with each of the aforementioned embodiments, the composition of the invention can contain a mass percentage of yucca juice greater than or equal to: 1; 2; 2.5; 3; 3.5; 4; 4.5; 5; 5.5; 6; 6.5 or 10.

Thus, the mass percentage of yucca juice can, regardless of the embodiment of the invention, be equal to: 0.025; 0.03; 0.05; 0.06; 0.075; 0.09; 0.1; 0.15; 0.18; 0.2; 0.25; 0.3; 0.6; 1 (dilute form); 1.5; 2; 2.5, 3; 3.5; 4; 4.5; 5; 5.5; 6; 6.5; or 10 (concentrated form).

Regardless of the embodiment, the mass percentage of the yucca juice can be less than 30 or 20.

Regardless of the embodiment, the composition of the invention can contain a mass percentage of iron greater than or equal to 0.1 and less than or equal to 4 or 5 and/or a mass percentage of copper greater than or equal to 0.1 and less than or equal to 4 or 5 and/or a mass percentage of potassium greater than or equal to 0.05 and less than or equal to 0.5 and/or a mass percentage of molybdenum greater than or equal to 0.01 and less than or equal to 0.05 and/or a mass percentage of manganese greater than or equal to 0.1 and less than or equal to 5 and/or a mass percentage of magnesium greater than or equal to 0.01 and less than or equal to 1.

Regardless of the embodiment, the composition of the invention can contain more particularly a mass percentage of iron greater than or equal to 0.6 and less than or equal to 0.9 and in particular equal to 0.77 and/or a mass percentage of copper greater than or equal to 0.3 and less than or equal to 0.45 and in particular equal to 0.375 and/or a mass percentage of magnesium greater than or equal to 0.12 and less than or equal to 0.19 and in particular equal to 0.15, and/or a mass percentage of potassium greater than or equal to 0.09 and less than or equal to 0.13 and in particular equal to 0.109 and/or a mass percentage of molybdenum greater than or equal to 0.0035 and less than or equal to 0.005 and in particular equal to 0.004 and/or a mass percentage of manganese greater than or equal to 0.9 and less than or equal to 2.7 and in particular equal to 1.18 or 2.24.

Regardless of the embodiment, the composition of the invention can, furthermore, contain at least one ingredient chosen from among humic acids, boron salts, zinc salts, acetic acid, citric acid, fructose, yeasts in particular Saccharomyces cerevisiae, iodine salts, lignosulphates, selenate salts, tungstate salts and liquid coffee extract.

According to a particular embodiment, it contains acetic acid, citric acid, fructose, iodine salts in particular potassium iodide, lignosulphates, in particular calcium lignosulphates, tungstate salts, in particular sodium tungstate, selenate salts, in particular sodium selenate, liquid coffee extract, and yeast extract in particular Saccharomyces cerevisiae.

Preferably, the composition of the invention in its concentration or dilute form contains the 6 ions in combination, each present in particular within the aforementioned ranges.

Preferably, the composition contains iron, magnesium, potassium and molybdenum.

Preferably, according to an embodiment that can be combined with each of the aforementioned embodiments, the composition furthermore contains, as the active ingredient, humic acids and/or boron and/or zinc.

The boron can be in the form of boron ethanolamine, for example.

According to another embodiment, that can be combined with each of the embodiments, it contains, as the trace element, zinc and/or iron and/or manganese and/or copper.

Advantageously, the mass percentage of boron is equal to or greater than 0.01 and less than or equal to 1 and more particularly greater than or equal to 0.04 and equal to or less than 0.06 and in particular equal to 0.05. The mass percentage of humic acids is equal to or greater than 0.01 and less than or equal to 10 and more particularly greater than or equal to 0.17 and equal to or less than 0.26 and in particular equal to 0.21.

The zinc can be presented in the form of zinc sulphate.

According to an embodiment that can be combined with each of the aforementioned embodiments, it contains a mass percentage of zinc greater than or equal to 0.1 and less than or equal to 10 and more particularly greater than or equal to 1.54 and less than or equal to 1.84 and in particular equal to 1.54.

The present invention also relates to a sprayable antifungal composition, for use in the field of agriculture which contains the composition of the invention diluted in a solvent and in particular water; more particularly, the sprayable composition can contain from 0.05% to 10% by mass of the composition of the invention and in particular 0.05%, 0.2%, 0.4%, 0.5%, 1%, 2%, 3%, 6% or 10% by mass of the aforementioned composition, diluted in a solvent and in particular water.

Advantageously, the sprayable composition has an acidic pH greater than or equal to 3.2. At these pH values, the sprayable composition proves, at efficacy doses, to be non-phytotoxic. The present invention also relates to the use of a composition or a sprayable composition according to the invention as an antifungal against at least one pathogen chosen from among Alternaria solani, Septoria tritici, Plasmopara viticola, Fusarium graminearum and Erysiphe necator, Pythium ultimum and Rhizoctonia solani.

The present invention also relates to a method for treating a plant particularly chosen from among the plants of the following families: Brassicaceae of which rapeseed, Fabaceae of which soybean, Vitaceae of which grapevine, Poaceae of which wheat, maize, Rosaceae of which apple and pear trees, Solanaceae of which potato, tomato, aubergine, Alliaceae of which onion, garlic, shallot or leeks, Apiaceae of which carrots, Asteraceae of which lettuce, artichoke or sunflower and Chenopodiaceae of which beetroot.

According to the invention, whereby the sprayable composition is applied on the leaves of said plant or the composition or said sprayable composition according to the invention is applied on the seeds of said plant.

The present invention also relates to the use of resveratrol and/or smilagenin and/or hecogenin and in particular a mixture of trans-resveratrol and smilagenin and/or hecogenin as an antifungal and in particular as an antifungal against a fungal foliar pathogen or a fungal soil pathogen chosen in particular from among Fusarium graminearum, Pythium ultimum and Rhizoctonia solani.

The present invention also relates to the use of a yucca juice for the treatment of a plant in particular chosen from among grapevine, solanaceae of which potato, tomato and aubergine, cereals of which wheat and maize against at least fungal pathogen living in soil and in particular chosen from among Alternaria solani, Septoria tritici, Plasmopara viticola, Fusarium graminearum et Erysiphe necator, Pythium ultimum and Rhizoctonia solani.

The present invention also relates to an antifungal composition which contains, as active ingredients, at least one compound chosen from among resveratrol, smilagenin and hecogenin and preferably which contains these three compounds and humic acids and/or boron. This composition can be available according to the same embodiments as the aforementioned composition, in respect of the concentrations of active agents, vehicles or solvents and pH, in particular. It can also be diluted in water according to the same dilutions as for the aforementioned sprayable composition. It can also be sprayed on the same plants as those described with reference to the composition described in the present application and containing at least one ion. The boron can be in the form of boron ethanolamine.

The present invention also relates to an antifungal composition which contains, as active ingredients, at least one compound chosen from among resveratrol, smilagenin and hecogenin and preferably which contains these three compounds and zinc, in particular zinc sulphate, for example. This composition can be available according to the same embodiments as the aforementioned composition in respect of the concentrations of active agents, vehicles or solvent and pH, in particular. It can also be diluted in water according to the same dilutions as for the aforementioned sprayable composition. It can also be sprayed on the same plants as those described with reference to the composition described in the application and containing at least one ion.

### Definitions

The term “trans-resveratrol” refers to 5-[(E)-2-(4-hydroxyphenyl)-ethenyl]benzene-1,3-diol.

The term “smilagenin” denotes (25R)-5beta-Spirostan-3beta-ol.

The term “hecogenin” denotes (3β,5α,25R)-3-Hydroxyspirostan-12-one

The terms “mass percentage of A” denote the mass fraction of A in a mixture of at least two ingredients.

The terms “volume percentage of A” denote the volume fraction of A in a mixture of at least two ingredients.

The terms “yucca trunk juice” denotes an aqueous composition containing in particular resveratrol, saponins of which smilagenin, trans-3,3′,5,5′-tetrahydroxy-4′-methoxystilbene, larixinol and phenolated derivatives denoted by the terms yuccaols A, B, C, D and E of yuccaone A and hecogenin, etc. Steroidal saponins only represent 6.8% by mass of saponins. Yucca trunk juice can also contain yucca leaf juice but preferably, it only contains juice from the trunk.

The term “yucca” denotes all the plants of the Yucca genus and preferably Yucca schidigera or Yucca gloriosa. The juice can be a mixture of juice from yucca of different types.

The yucca trunk juice is preferably heated to a temperature between 80° C. and 120° C. for a duration equal to or greater than 1 min and equal to or less than 10 min and preferably heated to 100° C. for 3 min.

The term “boron ethanolamine” denotes the complex formed by the combination of ethanolamine and boric acid.

The term “humic acids” denotes negatively charged, high-molecular-weight polymers, black to dark brown in colour, resulting from an oxidative condensation process and bound to amino acids, peptides and polysaccharides. They are present in humus.

Throughout the application, when mass percentages are given with reference to several ingredients, it should be understood that the mass percentages of these ingredients are independent.

### FIGURES

FIG. 1 represents the percentage of sporulating foliar surface area according to the treatments, the reference GA342 denotes the preferred mixture which makes it possible to obtain by dilution the composition of the invention, the volume percentage is indicated next to it, the control is pure water.

### EXPERIMENTAL EXAMPLES

### Yucca Juice

The yucca juice used is obtained by grinding and pressing Yucca schidigera trunks. The liquid obtained was heated to 100° C. for 3 min so as to be sterilised. This juice is used in all the experiments documented in the application.

Direct Tests Against Alternaria solani

### Identification of Active Compounds

Yucca juice is a complex mixture. It contains a large number of saponins, of which steroidal saponins. It also contains resveratrol, in particular in its trans form.

The Inventors identified yucca juice compounds that are effective as antifungal agents: these are resveratrol, smilagenin and hecogenin.

Aqueous solutions containing a given concentration of resveratrol or smilagenin were tested on a calibrated suspension of Alternaria solani spores.

The in vitro evaluations were performed with a 96-well micro-titration test. A range of concentrations of each compound was tested against a calibrated suspension of Alternaria solani spores. Three repetitions (wells) were carried out. The value EC₅₀ of each concentration against A. solani was determined based on its impact on reducing fungal growth measured using the optical density. The value EC₅₀ denotes the concentration to attain 50% efficacy of a product and the value EC₉₅ denotes the concentration of the product to attain 95% efficacy. The results are presented in Table 1 hereinafter which shows the % decrease in the growth of A. solani in contact with a solution containing a given concentration of resveratrol or smilagenin.

Throughout the application, the % indicated in the tables with reference to the tested compositions are mass %; the inhibition produced by the compositions tested is indicated as a % in the tables.

TABLE 1

| | resveratrol | smilagenin | hecogenin |
|---|---|---|---|
| Concentrations | inhibition | inhibition | inhibition |
| (μg/ml or ppm) | (%) | (%) | (%) |
| 0.0064 | 6.20 | 7.9 | 2.90 |
| 0.032 | 13.60 | 10.1 | 5.00 |
| 0.16 | 13.70 | 19.6 | 2.70 |
| 0.8 | 16.10 | 22.6 | 1.00 |
| 4 | 11.20 | 28.0 | 6.60 |
| 20 | 28.70 | 29.3 | 2.50 |
| 40 | | 30.00 | 6.80 |
| 100 | 54.70% | | |

Moreover, the inhibition on the aforementioned pathogen of various yucca juice compositions in water were tested. The results are compiled in Table 2 hereinafter.

TABLE 2

| Concentrations | |
|---|---|
| mass % of yucca | |
| juice | inhibition (%) |
| 0.05% | 0.0 |
| 0.5% | 12.7 |
| 1% | 16.0 |
| 2% | 23.8 |
| 3% | 29.0 |
| 6% | 34.7 |
| 10% | 45.1 |

It can be seen from the results in Table 1 that trans-3,4′,5-trihydroxystilbene (resveratrol trans from) of the stilbene family at the concentration of 100 ppm in water is capable of reducing the growth of A. solani by 54.7%. It can also be seen that smilagenin which is a steroidal saponin makes it possible to reduce the growth of A. solani by 30% to a concentration of 40 ppm in water. On the other hand, hecogenin has no antifungal action on the pathogen studied. It is likely that the antifungal action of yucca juice essentially stems from the combined presence of smilagenin in yucca juice. The lesser antifungal action of yucca juice is due to the lower concentration of resveratrol and smilagenin in the yucca juice. Indeed, in the above table, resveratrol and smilagenin are used diluted in water. As the smilagenin and resveratrol concentration in Yucca juice is lower than in the smilagenin and resveratrol compositions tested, the antifungal activity of yucca juice is lower than the dose of 2.5%. By increasing the Yucca concentration, the quantities of resveratrol and smilagenin increase in the same proportions and the efficacy of Yucca juice becomes noteworthy at 10%.

Synergistic Action of Active Compounds with Trace Elements

All the compositions described hereinafter have a density equal to or greater than 1.15 and equal to or less than 1.2. The pH of each of the solutions is acidic. It is for example adjusted by adding citric acid and/or acetic acid.

The following compositions were prepared:

### Composition V1

Composition V1 contains the ingredients indicated in Table 3 below.

TABLE 3

| Ingredients | Mass (g) |
|---|---|
| Water | 75.231 |
| Humic acids | 0.486 |
| Potassium salts | 0.243 |
| Magnesium salts | 0.486 |
| Molybdate salts | 0.010 |
| Copper salts | 1.500 |
| Iron salts | 4.049 |
| Zinc salts | 7.000 |
| Boron salts | 0.486 |
| Manganese salts | 3.706 |
| Yucca juice | 2.500 |
| | 100.000 |

The salts are sulphates except for potassium which is introduced in potassium chloride form. Molybdate is introduced in sodium molybdate form.

### Composition V6

Composition V6 contains the ingredients indicated in Table 4 below.

TABLE 4

| Products | mass % |
|---|---|
| Water | 84.198 |
| Yucca juice | 2.5 |
| Manganese salts | 7.000 |
| Potassium salts | 0.243 |
| Iron salts | 4.049 |
| Magnesium salts | 0.500 |
| Copper salts | 1.500 |
| Molybdate salts | 0.010 |

The salts are sulphates except for potassium which is introduced in potassium chloride form. Molybdate is introduced in sodium molybdate form.

Dilutions of some of the aforementioned compositions were produced as indicated in Table 5 hereinafter.

The solutions obtained were tested directly on the pathogen A. solani as indicated above. The results are compiled in Table 5. The percentages with reference to the tested compositions are mass percentages.

TABLE 5

| | mass % of tested composition in water | | | | | | |
|---|---|---|---|---|---|---|---|
| Tested composition | 0.05% | 0.50% | 1.00% | 2.00% | 3.00% | 6.00% | 10.00% |
| Composition V1 | 0.00 | 41.26 | 67.19 | 86.25 | 100.0 | 100.0 | 100.0 |
| 1.5% manganese | 0.00 | 10.0 | 20.7 | 53.38 | 100 | 100 | 100 |
| salts + water + 2.5% | | | | | | | |
| yucca juice | | | | | | | |
| 1.5% copper salts + | 0.0 | 0.0 | 13.2 | 36.0 | 74.9 | 100.0 | 100.0 |
| water + 2.5% yucca | | | | | | | |
| juice | | | | | | | |
| 4.05% iron salts + | 0.0 | 0.0 | 1.2 | 12.3 | 15.0 | 40.1 | 84.6 |
| water + 2.5% yucca | | | | | | | |
| juice | | | | | | | |
| 0.24% potassium | 3.7 | 13.5 | 10.3 | 16.0 | 18.1 | 18.5 | 16.8 |
| salts + water + 2.5% | | | | | | | |
| yucca juice | | | | | | | |
| 0.5% magnesium | −2.1 | 5.5 | 8.1 | 6.5 | 4.8 | 3.1 | −2.6 |
| salts + water + | | | | | | | |
| 2.5% yucca juice | | | | | | | |
| 0.01% molybdate | 9.1 | 29.0 | 28.4 | 25.8 | 27.0 | 17.5 | 19.2 |
| salts + water + 2.5% | | | | | | | |
| yucca juice | | | | | | | |
| water + 2.5% yucca | 0.0 | 0.0 | 0.0 | 0.0 | 7.1 | 29.9 | 65.5 |
| juice | | | | | | | |
| Composition V6 | 0.00 | 77.10 | 109.80 | 102.90 | 103.30 | 97.8 | 102.2 |

The salts used are the same as those in composition V6.
Table 6 hereinafter compiles the EC₅₀ and EC₉₅ values of the different mixtures tested on A. solani.

TABLE 6

| | EC₅₀ | EC₉₅ |
|---|---|---|
| Tested composition | (mass %) | (mass %) |
| Composition V1 | 0.65% | 2.53 |
| Composition V6 | 0.31 | 1.30 |
| 4.05% iron salts + 2.5 g yucca | 5.85 | >10% |
| juice + water | | |
| 0.24% KCl + water + 2.5% | >10% | >10% |
| yucca juice | | |
| 0.5% magnesium salts + | >10 | >10 |
| water + 2.5% yucca juice | | |
| 1.5% copper salts + water + | 2.11 | 2.80 |
| 2.5% yucca juice | | |
| 0.01% molybdate salts + | >10 | >10 |
| water + 2.5% yucca juice | | |
| 3% yucca juice + water | 7.96 | >10 |

In the light of the results of Tables 5 and 6, it is observed that compositions V1 and V6 diluted in water are effective against A. solani, which is not the case of the composition containing only 2.5% yucca juice or only yucca juice and one of the trace elements.
The presence of the mixture of trace elements and in particular copper lowers the EC₅₀ value.
In Vitro Effect on R. solani

Dilutions of some of the aforementioned compositions were produced as indicated in Table 7 hereinafter.

The solutions obtained were tested directly on the pathogen R. solani as indicated above. The results are compiled in Table 7. The percentages are mass percentages.

TABLE 7

| | mass % | V1 | V6 | Yucca juice 1 | Yucca juice 2 |
|---|---|---|---|---|---|
| R. solani | 0.05% | 101.3 | 0 | 0.3 | 8.6 |
| | 0.50% | 100.5 | 0 | −5.3 | 95.2 |
| | 1.00% | 101.7 | 72.1 | 3.6 | 98.0 |
| | 2.00% | 96.8 | 101.5 | 32.5 | 101.3 |
| | 3.00% | 97.9 | 93.5 | 40.4 | 101.1 |
| | 6.00% | 90.9 | 96.0 | 56.7 | 98.7 |
| | 10.00% | 91.5 | 92.7 | 62.0 | 100.3 |

| | | | | |
|---|---|---|---|---|
| EC₅₀ (%) | <0.05 | 0.93 | 0.15 | 0.93 |
| EC₉₅ (%) | <0.05 | 1.65 | 0.49 | 1.65 |

It is observed in the light of the results of the aforementioned table that composition V1 is effective once it is at the mass percentage of 0.05% whereas composition V6 is effective against R. solani from 1% or 2%. It is also observed that yucca juices 1 and 2 which are Yucca schidigera juices from different producers do not have the same efficacy on R. solani. At the dose of 0.5%, “Yucca juice 1” has an efficacy of 0 whereas “Yucca juice 2” records a performance of 95.2%. This difference in efficacy clearly shows that it is not possible to produce a standard effective composition reproducibly directly using products derived from plants. Throughout the application, compositions V1 and V6 are manufactured from aforementioned yucca juice 1.
Direct In Vitro Tests Against Plasmopara viticola—Septoria tritici—Fusarium graminearum—Erysiphe necator

The evaluations were performed with a 96-well micro-titration test to evaluate the in vitro fungicidal activity of each solution.

A range of concentrations (up to 8) of each solution was tested against a calibrated suspension of Fusarium graminearum spores and against a calibration suspension of Zymoseptoria tritici.

Three repetitions (wells) were carried out. The value of the concentration making it possible to inhibit the growth of each pathogen (EC₅₀) to 50% was determined using the optical density measurement.

a) Fusarium graminearum

Fusarium graminearum belongs to the Gibberella zeae species, ascomycetes fungi of the Nectriaceae family. This fungus is the pathogenic agent of dry rot of cereals and maize causing burdensome yield losses. It induces contaminations of the harvested grains by mycotoxins (fusariotoxins) hazardous for human and animal health.

This disease also develops both on seeds in soil and on foliage in season.

The experimental results obtained according to the same protocol described above are represented in Table 8 hereinafter. The percentages are mass percentages.

TABLE 8
F. graminearum

| | | | Mixture of |
|---|---|---|---|
| | | | water + 2.5% |
| mass % of tested | | | by mass of |
| mixture in water | V6 | V1 | yucca juice |
| 0.05% | 0 | 19.2 | 3.4 |
| 0.5% | 0 | 57.3 | 9.7 |
| 1% | 49.8 | 76.1 | 24.2 |
| 2% | 107.1 | 80.8 | 30.3 |
| 3% | 107.3 | 87.5 | 36.6 |
| 6% | 109.3 | 100.0 | 38.9 |
| 10% | 109.3 | 100.0 | 40.7 |
| EC₅₀ (%) | 1.05 | 0.34 | >10 |
| EC₉₅ (%) | 1.65 | 4.40 | >10 |

It is observed in the light of the results of Table 8 that adding the trace elements makes it possible to lower by almost 3-fold the quantity of yucca juice to be added in water to obtain a 100% efficacy.

The effect of the active compounds was tested on Fusarium graminearum. The results are presented in Table 9 hereinafter.

TABLE 9

| Concentrations | | | |
|---|---|---|---|
| (μg/ml or ppm) | Resveratrol | Hecogenin | Smilagenin |
| 0.0064 | 0.30 | 2.40 | 5.00 |
| 0.032 | −2.90 | −4.50 | −2.60 |
| 0.16 | −3.90 | −1.40 | −0.80 |
| 0.8 | −1.60 | −1.50 | 2.40 |
| 4 | −3.80 | 0.00 | 1.50 |
| 20 | 18.20 | −2.70 | −8.70 |
| 100 | 53.30 | −6.40 | 2.00 |
| EC₅₀ (μg/ml or | 29.49 | >100 | >100 |
| ppm) | | | |
| EC₉₅ (μg/ml or | >100 | >100 | >100 |
| ppm) | | | |

Resveratrol (trans) at 100 ppm makes it possible to reduce Fusarium graminearum infestation by more than 50%.
b) Septoria tritici

Septoria tritici is an ascomycetes fungus responsible for glume blotch of wheat. Its average damage is estimated at 17 q/ha (up to 50 q/ha in the most exposed scenarios). Due to its frequency and the extent of the potential damage, S. tritici is the most significant disease of common wheat.

The same experiments as those aforementioned were carried out. The results are compiled in Tables 10 and 11 hereinafter. The percentages given are mass percentages.

TABLE 10

| | Concentrations | | Water + 10% | water + 2.5% |
|---|---|---|---|---|
| | (%) | V1 | yucca juice | yucca juice |
| S. tritici | 0.05% | 19.10 | 14.3 | 6.9 |
| | 0.50% | 40.30 | 67.4 | 16.2 |
| | 1.00% | 65.50 | 80.1 | 33.6 |
| | 2.00% | 91.70 | 86.4 | 42.7 |
| | 3.00% | 96.4 | 85.7 | 46.5 |
| | 6.00% | 100.0 | 85.8 | 50.6 |
| | 10.00% | 100.0 | 86.3 | 53.3 |

| | | | |
|---|---|---|---|
| EC₅₀ (%) | 0.89 | 0.44 | 4.42 |
| EC₉₅ (%) | 2.58 | >10 | >10 |

TABLE 11

| | Concentrations | | water + 2.5% | |
|---|---|---|---|---|
| | (%) | V1 | yucca juice | V6 |
| S. tritici | 0.05% | −7.2 | −1.6 | −2.6 |
| | 0.50% | 6.0 | 43.8 | 89.7 |
| | 1.00% | 44.3 | 75.6 | 91.0 |
| | 2.00% | 63.9 | 90.0 | 99.2 |
| | 3.00% | 80.0 | 94.1 | 97.4 |
| | 6.00% | 100.0 | 100.8 | 100.4 |
| | 10.00% | 100.0 | 107.0 | 100.4 |

| | | | |
|---|---|---|---|
| EC₅₀ (%) | 1.25 | 0.68 | 0.17 |
| EC₉₅ (%) | 4.90 | 3.05 | 1.50 |

It is observed that the solution containing composition V1 shows a total efficacy at a concentration of 6% by mass of composition V1. At this concentration, the water+yucca juice mixture shows an efficacy of 100%. Dilute composition V6 has an efficacy once it is present at 0.5% or 1% by mass. It is found to be more effective than composition V1. It is therefore observed that adding trace elements increases the antifungal property of yucca juice and therefore the antifungal property of at least one of the identified active compounds which are resveratrol, smilagenin and hecogenin.

The antifungal property of the active compounds was tested on S. tritici. The results are compiled in Table 12 hereinafter. The figures show the % inhibition of pathogen growth.

TABLE 12

| Concentrations | | | |
|---|---|---|---|
| (μg/ml or ppm) | Resveratrol | Hecogenin | Smilagenin |
| 0.0064 | 0.00 | 13.50 | −3.90 |
| 0.032 | −0.40 | 13.70 | −2.30 |
| 0.16 | −0.40 | 11.50 | −1.90 |
| 0.8 | 0.60 | 12.90 | −9.50 |
| 4 | −2.60 | 12.30 | 0.00 |
| 20 | −2.00 | 22.80 | −2.10 |
| 100 | 104.90 | 20.50 | −0.20 |
| EC₅₀ (μg/ml or | 72.01 | >100 | >100 |
| ppm) | | | |

Resveratrol and hecogenin show efficacies against Septoria tritici at very low concentrations, 100 ppm and 20 ppm, respectively.

c) Test on P. ultimum

The same experiments as those aforementioned were carried out. The results are compiled in Tables 13 and 14 hereinafter. The percentages given are mass percentages except for the inhibition %.

TABLE 13

| | mass % | V1 |
|---|---|---|
| P. ultimum | 0.05 | 101.9 |
| | 0.50 | 104.8 |
| | 1.00 | 105.2 |
| | 2.00 | 109.7 |
| | 3.00 | 109.3 |
| | 6.00 | 101.9 |
| | 10.00 | 109.4 |

| | |
|---|---|
| EC₅₀(%) | <0.05 |
| EC₉₅(%) | <0.05 |

TABLE 14

| Concentrations | | | |
|---|---|---|---|
| (μg/ml or ppm) | resveratrol | hecogenin | smilagenin |
| 0.0064 | −8.20 | 12.80 | −6.70 |
| 0.032 | −0.30 | 20.70 | 0.00 |
| 0.16 | 0.00 | 28.80 | −0.60 |
| 0.8 | −1.70 | 36.30 | 0.10 |
| 4 | 23.30 | 55.10 | −3.40 |
| 20 | 72.40 | 68.40 | −0.10 |
| 100 | 101.30 | 85.20 | 0.00 |
| EC₅₀ (μg/ml or | 8.89 | 2.87 | >100 |
| ppm) | | | |
| EC₉₅ (μg/ml or | 73.85 | >100 | >100 |
| ppm) | | | |

It is observed that resveratrol and hecogenin are effective respectively at 100% and 85% at the dose of 100 ppm. It is observed that composition V1 provides 100% efficacy at low concentrations, from 0.05% (Table 13). The association of the active molecules resveratrol and hecogenin associated with trace elements makes it possible to attain total efficacy at the lowest concentrations, from 0.05%.
d) Test on Rhizoctonia solani

The same experiments as those aforementioned were carried out. The results are compiled in Table 15 hereinafter. The percentages given are mass percentages.

TABLE 15

| | | | water + 2.5% | |
|---|---|---|---|---|
| | mass % | V1 | yucca juice | V6 |
| R. solani | 0.05% | 101.3 | 0.3 | −3.6 |
| | 0.50% | 100.5 | −5.3 | −2.0 |
| | 1.00% | 101.7 | 3.6 | 72.1 |
| | 2.00% | 96.8 | 32.5 | 101.5 |
| | 3.00% | 97.9 | 40.4 | 93.5 |
| | 6.00% | 90.9 | 56.7 | 96.0 |
| | 10.00% | 91.5 | 62.0 | 92.7 |

| | | | |
|---|---|---|---|
| EC₅₀ (%) | <0.05 | 4.60 | 0.93 |
| EC₉₅ (%) | <0.05 | >100 | 1.65 |

It is observed that composition V1 is more active than composition V6 probably on account of the presence of humic acids and/or boron salt.

Test on Plasmopara viticola Zoospores

The objective is to evaluate the direct in vitro effect of the composition of the invention on the motility of grapevine mildew (Plasmopara viticola) zoospores suspended in water. Mildew (Plasmopara viticola) is a subpopulation originating from the Burgundy wine region, maintained by weekly transplanting on plants. The experiments are carried out in vitro: Plasmopara viticola sporangia are harvested on a sporulating grapevine leaf (inoculated 7 days previously) and cultured suspended in ultrapure water at a concentration of at least 106 sporangia/ml. The sporangia release motile zoospores within one hour. This motility is verified at the end of experimenting on the control suspension.

Dilutions using sporangium solutions are prepared extemporaneously in ultrapure water to obtain a final zoospore concentration of 0.33% by mass.

The effect on zoospore motility is observed in an interval of 5 minutes, using a Malassez cell, under a microscope. A response gradient is observed within this interval and noted according to the following scale:

High efficacy or 100%: all the zoospores are non-motile (or destroyed), The results are represented in Table 16 hereinafter. The percentages are mass percentages.

TABLE 16

| | | Test on grapevine | |
|---|---|---|---|
| Tested | | cuttings against | Direct test against |
| compositions | mass % | Plasmopara viticola | Plasmopara viticola |
| V1 | 0.0033 | / | high eff-100 |
| V1 | 0.033 | / | 100 |
| V1 | 0.33 | 98-100% | 100 |
| V1 | 0.67 | 98-100% | / |
| Yucca juice | 0.0033 | / | 0 |
| Yucca juice | 0.033 | / | high eff |
| Yucca juice | 0.33 | 71-89 | 100 |

It is observed in the light of the results in Table 16 that dilute composition V1 inhibits Plasmopara viticola zoospore motility at the reference concentration of 0.033% (v/v). Even diluted at a rate of 0.0033%, the mixture inhibits or disrupts the motility of thezoospores of the pathogen. The density of the product being equal to or greater than 1.15 and equal to or less than 1.2, the mass percentage of composition V1 equivalent to the 0.0033 dilution is equal to 0.004% which is equivalent to a mass percentage of yucca juice equal to 0.00012%. Here again, it is observed that the presence of the ions increases the antifungal activity of resveratrol and smilagenin contained in yucca juice. Yucca juice alone at the dose of 0.33% exhibits an action against zoospore motility at a 100-fold higher concentration (0.33%).

### Test on Plants Under Controlled Conditions

Tests on plants under controlled conditions make it possible to move closer to actual conditions of use of plant protection products.

In these tests, the product under test is no longer placed directly in vitro in contact with the pathogen but sprayed onto the leaves of the plant. The latter is grown in greenhouses and therefore in light. The efficacy of the product under near-actual conditions is thus verified.

Tests Under Controlled Conditions—Plasmopara viticola on Grapevine

The plant material consists of 2-month-old herbaceous cuttings of the Marselan varietal (Grenache×Cabernet-Sauvignon) multiplied in INRAE greenhouses, grown in 0.5 L pots (⅔ potting soil-⅓ perlite). At 2 months, the cuttings have 5-6 spread-out leaves. The mildew (Plasmopara viticola) inoculum is a subpopulation originating from the Burgundy wine region, maintained by weekly transplanting on plants. At least five plants are used per modality.

The composition of the invention under test is sprayed on the cuttings with a manual sprayer below the runoff point, on both sides of the leaves. The droplets are allowed to dry for 2 to 3 hours before the plants are put back in a greenhouse.

The plants are inoculated 48 h post-treatment, by spraying a suspension Plasmopara viticola sponrangia (104 sporangia/ml) prepared extemporaneously, on the bottom side of the leaves. After inoculation, the plants are placed in a humid tent for at least 3 hours to allow zoospore encystment and they are then put back in a greenhouse.

In grapevines, very young leaves (approximately at ⅓ of their definitive size) and old leaves are resistant to disease (ontogenic resistance). For this reason, the observation of the disease is generally performed on 2 susceptible leaves designated as rank 1 leaf and rank 2 leaf. Rank 1 corresponds to a leaf that has attained approximately ⅔ of is definitive surface area, the rank 2 leaf, located immediately below that of rank 1, is an adult-sized leaf, still susceptible to mildew.

Five days after inoculation, at least 6 disks of 1.3 cm in diameter per leaf and per rank are sampled with a puncher, disposed immediately with the adaxial face on wet paper, in a Plexiglas dish. The latter is left for 2 days in a culture chamber (day 10 h 20° C./night 14 h 18° C.) to allow sporulation. The results correspond to the percentage of disk surface area covered by the sporangiophores, determined by image analysis. The infection percentage values indicated in the graphs for each treatment correspond to the mean of the values obtained for 30 “rank 1” disks or 30 “rank 2” disks. The observation of the sporulation rate is carried out by image analysis for scoring on the rank 1 and 2 leaves. A 5% rate corresponds to a clear visually established infection, a rate greater than 10% indicates substantial infection (the disk is almost entirely covered with sporangia).

The 1st test was carried out with initially recommended doses of 1 L, 2 L and 3 L/ha diluted in 150 L/ha, i.e. 6.67 ml/L, 13.33 ml/L and 20 ml/L. The following 2 experiments were carried out with lower doses: 1.67 ml/L, 3.33 ml/L and 6.67 ml/L.

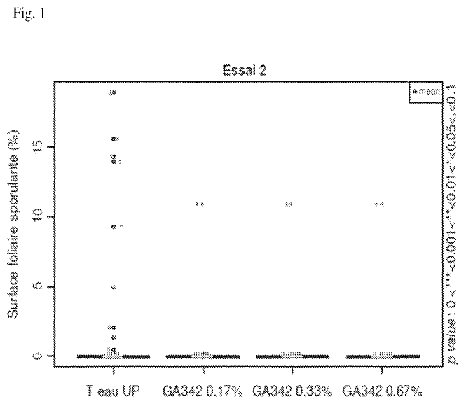

The reference GA342 denotes composition V1 in FIG. 1. The dilution is given next to it. The means were compared with Tukey's T-test (comparison of the solution containing composition V1 with the water control).

The mean efficacy of composition V1 at the dose of 0.33% on 5 tests is 98.7%. The efficacy of composition V1 against grapevine mildew is almost complete from the dose of 1.7 mL/L i.e. 0.17% in volume. Inhibition under in vitro conditions is well correlated with that under in vivo conditions. The density of the composition being equal to or greater than 1.15 and equal to or less than 1.2.

Regarding composition V6, it was found to be effective in vivo on grapevine against Plasmopara viticola at a concentration of 0.50% or 2% by mass of a mother tincture containing 10% by mass of composition V6 diluted in water.

Moreover, other mixtures containing water, yucca juice were tested against Plasmopara viticola on grapevine according to the same protocol as that aforementioned (3 repetitions of 2 or 3 foliar sprays at a 1-week interval). The results are compiled in Table 17 hereinafter.

TABLE 17

| | | Plant: |
|---|---|---|
| | | grapevine |
| | volume % | Efficacy on |
| | of tested | Plasmopara |
| Tested composition | composition | viticola (%) |
| V1 | 0.67-1.33-2 | 100 |
| | 0.17 | 98-100 |
| | 0.0033 | / |
| | 0.033 | / |
| | 0.33 | 100 |
| | 0.67 | 98-100 |
| Yucca juice 3 g + water 83.7 g | 0.33 | 71 |
| Copper salts 1.5 g + water 94.5 g + | 0.33 | 99 |
| yucca juice 3 g | | |
| Zinc salts 7 g + water 80 g + yucca juice | 0.33 | 96 |
| 3 g | | |
| Humic acids 0.486 g + water 96.514 g + | 0.33 | 97 |
| yucca juice 3 g | | |
| Boron salts 0.486 g + water 95.514 g + | 0.33 | 96 |
| yucca juice 3 g | | |
| water 83.2 g + yucca juice 3 g + Mg | 0.33 | 27 |
| salts MgSO₄ 0.5 g | | |
| Water 90 g + yucca juice 3 g + Mn salts | 0.33 | 71 |
| 7 g | | |
| Water 96.76 g + yucca juice 3 g + K | 0.33 | 51 |
| salts 0.24 g | | |
| Water 92.95 g + yucca juice 3 g + Fe | 0.33 | 83 |
| salts 4.05 g | | |

The salts are sulphates except for potassium which is used in potassium chloride form.
It is observed in the light of the results in Table 17 that adding the trace element mixture increases the antifungal activity of the composition of the invention.
In conclusion, it is observed that the composition according to the invention used in light and on a plant remains effective as an antifungal.

### Field Tests (Composition V1)

In field tests, it is observed in FIG. 1 that composition V1 makes it possible to reduce initial mildew infestations significantly on leaves and clusters compared to a control. The dose of 3 l/ha improves efficacy compared to lower doses of 1 and 2 l/ha. The efficacy level attains 60% on leaves and clusters. In FIG. 1, the percentage (%) is a volume percentage. Thus, in this FIGURE, 0.17% indicates that 1.7 mL of composition V1 was dissolved in 998.3 mL of water. As a mass percentage, the tested solution contains 0.20% of composition V1.

### Effect of pH on Efficacy and Phytotoxicity

In the aforementioned example, the compositions obtained using composition V1 had different pHs, as indicated in Table 18 hereinafter. The percentages (%) given are volume percentages.

TABLE 18

| | 0.17% | 0.33% | 0.67% |
|---|---|---|---|
| pH | 3.48 | 3.28 | 3.06 |

Minor necrosis was observed with the concentration of 0.67%, identical to those of the first test at the same concentration; the two lowest concentrations are less aggressive.
It is therefore observed that diluting composition V1 makes it possible to increase its pH and therefore lower its phytotoxicity without decreasing its efficacy.

### Other Compositions According to the Invention Tested

The following compositions V9, V10, GAST 1 and GAST 2 (ingredients compiled in Table 19 below) were also tested.

TABLE 19

| | V10 | V9 | GAST1 | GAST2 |
|---|---|---|---|---|
| Products | mass % | mass % | mass % | mass % |
| Water | 76.230 | 64.423 | 72.645 | 77.210 |
| Yucca juice | 10.000 | 10.000 | 0.500 | 10.000 |
| Manganese sulphate | 7.000 | 7.000 | 9.500 | 5.000 |
| (monohydrate) | | | | |
| Potassium chloride | 0.243 | 0.243 | 0.500 | 0.500 |
| Iron sulphate (monohydrate) | 4.049 | 4.049 | 0.900 | 0.500 |
| Magnesium sulphate | 0.500 | 0.500 | 1.000 | 1.000 |
| Copper sulphate (pentahydrate) | 1.500 | 1.500 | 1.300 | 0.000 |
| Sodium molybdate (dihydrate) | 0.010 | 0.010 | 0.020 | 0.020 |
| Spirit vinegar (acetic acid) | 0.469 | 0.469 | 1.300 | 1.300 |
| Humic acids | 0.000 | 0.4858 | 1.000 | 1.000 |
| Fructose | 0.000 | 0.04858 | 0.100 | 0.100 |
| Potassium iodide | 0.000 | 0.010 | 0.020 | 0.020 |
| Calcium lignosulphate | 0.000 | 0.729 | 1.500 | 1.500 |
| Cobalt sulphate (heptahydrate) | 0.000 | 0.024 | 0.050 | 0.050 |
| Zinc sulphate monohydrate | 0.000 | 7.000 | 1.070 | 0.000 |
| Nickel sulphate | 0.000 | 0.002 | 0.000 | 0.000 |
| Boron ethanolamine | 0.000 | 0.4858 | 1.000 | 1.000 |
| Sodium tungstate | 0.000 | 0.002 | 0.000 | 0.000 |
| Citric acid | 0.000 | 3.000 | 0.600 | 0.600 |
| Sodium selenate | 0.000 | 0.020 | 0.000 | 0.000 |
| Liquid coffee extract | 0.000 | 0.000 | 0.200 | 0.200 |
| Yeast extract (S. cerevisiae) | 0.000 | 0.000 | 0.600 | 0.000 |

The EC₅₀ and EC₉₅ values on the different pathogens were determined in vitro as indicated above. The results are compiled in Table 20 below. The EC values correspond to the mass percentage of composition V10 diluted in water to obtain a 50% or 95% decrease in pathogen growth.

TABLE 20

| Composition | V10 | V10 | V1 | V1 |
|---|---|---|---|---|
| Pathogen | EC₅₀ (%) | EC₉₅ (%) | EC₅₀ (%) | EC₉₅ (%) |
| A. solani | 0.1 | 0.3 | 1.0 | 1.1 |
| Z. tritici | 0.33 | 1.77 | 0.68 | >10 |
| F. graminearum | 1.02 | 2.94 | 0.86 | 2.76 |
| R. solani | 0.52 | 0.58 | 0.30 | >10 |

Regarding grapevine mildew (Plasmopara viticola), the mean efficacy in vitro of composition V10 diluted to 50% by mass in water is 99.29% for spore release and 99.54 on spore motility). Moreover, tests on plants were also performed. Dilute composition V10 (0.5% by mass of V10 in 95% water) was found to be effective against Plasmopara viticola. The mean efficacy of composition V10 at the dose of 0.5% on 7 tests is 85.9% according to the procedure already explained on greenhouse plants.

Regarding composition V9, it was found to be effective in vitro against S. tritici, F. graminearum, Pythium u. R. solani, Alternaria s. and Plasmopara. It was found to be effective against Plasmopara viticola and powdery mildew of grapevine (Erysiphe necator) in vivo at dilutions in water at 0.05% or 2% by mass of a stock solution containing 10% by mass of composition V9 indicated in Table 19.

Regarding compositions GAST 1 and GAST 2, the in vitro test results (same protocol as mentioned above) are compiled in Table 21 below. The mass percentage refers to the compositions described in Table 19, which are diluted in water. For the mass percentage of composition given, 100% in vitro efficacy is obtained. Compositions GAST 1 and GAST2 are preferably used to treat seeds.

TABLE 21

| Pathogen | GAST 1 (EC₅₀/mass %) | GAST 2 (EC₅₀/mass %) |
|---|---|---|
| R. solani | 1.21/10% | 0.71/10% |
| A. solani | 6.2/10% | 0.5/6% |
| Z. tritici | >10 | 0.63/6% |
| T. caries | 0.06 | 0.6 |

In Vitro Results Showing the Syngergistic Action of Yucca Juice with the Other Compounds of the Composition According to the Invention on A. solani, Z. tritici, and Plasmopara viticola,

The following tables show in vitro the synergistic antifungal action between yucca juice and the other compounds of the composition of the invention on various pathogens. The concentrations given are as a mass %. The solutions tested as aqueous solutions.

Mo denotes sodium molybdate, Bo denotes boron ethanolamine.

TABLE 22

| | | | | | | | Humic | | | | |
|---|---|---|---|---|---|---|---|---|---|---|---|
| | Concentration | Mn | Mn | Cu | Fe | Zn | acids | KCl | Mg | Mo | Bo |
| | (%) | 3.7% | 7% | 1.5% | 4% | 7% | 0.49% | 0.24% | 0.5% | 0.01% | 0.49% |
| A. | 0.05% | −2.3 | 0.0 | −2.8 | −4.7 | −1.4 | 3.1 | 1.2 | −1.2 | 2.2 | 6.5 |
| solani | 0.50% | 0.0 | 16.9 | −1.4 | −4.3 | 6.3 | 6.4 | −3.6 | −8.0 | −1.2 | 0.9 |
| | 1.00% | 12.8 | 29.6 | −1.9 | −0.4 | 16.6 | 9.0 | −3.9 | −2.2 | −7.4 | −0.5 |
| | 2.00% | 15.1 | 73.2 | −1.8 | 49.6 | 32.1 | 2.1 | −8.9 | −1.8 | −1.3 | −2.6 |
| | 3.00% | 17.6 | 89.4 | −4.9 | 100.0 | 37.2 | −1.7 | −1.3 | −1.3 | −1.8 | 2.4 |
| | 6.00% | 38.8 | 94.5 | −1.8 | 100.0 | 49.7 | −2.1 | −1.2 | −2.5 | −1.5 | −3.6 |
| | 10.00% | 48.4 | 101.1 | −2.9 | 100.0 | 59.1 | −1.6 | −2.9 | −2.4 | −0.4 | −3.3 |

| | | | | | | | | | | |
|---|---|---|---|---|---|---|---|---|---|---|
| EC₅₀ (%) | 10.2 | 1.2 | >10 | 2.1 | 6.4 | >10 | >10 | >10 | >10 | >10 |
| EC₉₅ (%) | >10 | 6.4 | >10 | 2.3 | >10 | >10 | >10 | >10 | >10 | >10 |

It is observed that for the other compounds alone in solution in water, EC₅₀ values greater than those of the compositions of the invention in respect of antifungal action on A. solani are obtained.

TABLE 23

| | Concentrations | Mn | Mn | Cu | Fe | Zn | | KCl | Mg | Mo | Bo |
|---|---|---|---|---|---|---|---|---|---|---|---|
| | (%) | 3.7% | 7% | 1.5% | 4% | 7% | humic a | 0.24% | 0.5% | 0.01% | 0.49% |
| Z. | 0.05% | 12.9 | 11.3 | 11.9 | 9.8 | −4.9 | −1.1 | 4.7 | 0.7 | −1.7 | 8.6 |
| tritici | 0.50% | 13.8 | 27.6 | 17.3 | 37.1 | 28.1 | −1.2 | 2.2 | 0.9 | −1.1 | 7.6 |
| | 1.00% | 12.9 | 33.5 | 22.1 | 38.8 | 39.8 | −2.8 | 1.4 | 2.3 | −2.3 | 5.3 |
| | 2.00% | 18.6 | 28.7 | 23.6 | 54.9 | 44.1 | −6.6 | 0.1 | −2.9 | −2.2 | −1.6 |
| | 3.00% | 20.0 | 28.0 | 20.9 | 100.0 | 47.4 | −7.8 | 0.3 | −0.1 | −1.8 | −0.8 |
| | 6.00% | 17.0 | 29.0 | 24.1 | 100.0 | 65.0 | 6.0 | 7.9 | 11.3 | −1.6 | −4.3 |
| | 10.00% | 23.1 | 29.5 | 28.2 | 100.0 | 77.2 | 13.2 | 3.8 | 12.3 | −2.2 | −1.0 |

| | | | | | | | | | | |
|---|---|---|---|---|---|---|---|---|---|---|
| EC₅₀ (%) | >10 | >10 | >10 | 1.36 | 2.49 | >10 | >10 | >10 | >10 | >10 |
| EC₉₅ (%) | >10 | >10 | >10 | 2.86 | >10 | >10 | >10 | >10 | >10 | |

It is observed that for the other compounds alone in solution in water, EC₅₀ values greater than those of the compositions of the invention in respect of antifungal action on Z. tritici are obtained. At the dose of 0.5%, only iron sulphate and yucca juice provide efficacy which is nonetheless low, of the order of 37% and 42% respectively. Nevertheless, formulated product V9 provides an efficacy of 58% against glume blotch which is greater than the ingredients alone. These comparisons therefore prove the complementary effects of yucca juice and the ions. Concentrated yucca juice at a rate of 10% exhibits a remarkable efficacy of almost 92% from a 1% dose of use. The same salts as those contained in the composition of the invention were used in order to be able to compare efficacies.

TABLE 24

| Concentration | Mn | Mn | Zn | | KCl | Mg | Mo | Bo |
|---|---|---|---|---|---|---|---|---|
| (%) | 3.7% | 7% | 7% | humic a | 0.24% | 0.5% | 0.01% | 0.49% |
| 0.00% | 0.00 | 0.00 | 0.00 | 0.00 | 0.00 | 0.00 | 0.00 | 0.00 |
| 0.05% | 31.02 | 25.41 | 7.02 | 8.66 | 10.83 | 13.88 | 15.33 | 17.33 |
| 0.50% | 87.05 | 89.41 | 50.25 | 4.04 | 51.35 | 43.93 | 46.43 | 68.80 |
| 1.00% | 94.13 | 94.78 | 65.51 | 32.28 | 69.10 | 53.33 | 53.15 | 84.60 |
| 2.00% | 97.24 | 97.25 | 99.08 | 64.87 | 75.81 | 69.80 | 72.42 | 90.99 |
| 3.00% | 97.70 | 97.53 | 99.29 | 65.22 | 83.20 | 76.51 | 74.22 | 95.55 |
| 6.00% | 97.72 | 97.69 | 98.93 | 85.08 | 94.91 | 91.75 | 74.22 | 98.96 |
| 10.00% | 97.79 | 97.64 | 99.08 | 94.32 | 97.43 | 95.94 | 96.02 | 99.00 |

It is observed that for the other compounds alone in solution in water, they are active against Plasmopara viticola at higher concentrations than their concentration in the composition of the invention.

### In Vivo Efficacy Results on Grapevine Against Powdery Mildew of Grapevine

The table below compiles the antifungal activity of the various compositions according to the invention.

The AUDCP (trapezoidal area) was used. The method used is that of Campbell and Madden published in 1990. DSI means Disease Symptom Intensity. DPI corresponds to the number of Days Post-Inoculation.

TABLE 25

| | | | | | | | | Efficacy |
|---|---|---|---|---|---|---|---|---|
| | DSI | | DSI | | DSI | | | calculated |
| | (%) | Efficacy | (%) | Efficacy | (%) | Efficacy | | via |
| Conditions | 5DPI | 5DPI | 7DPI | 7DPI | 13DPI | 13DPI | AUDPC | Audpc |
| No | 20.5 | — | 55.4 | — | 75.9 | — | 521.0 | — |
| treatment | | | | | | | | |
| V1 - 0.5% | 3.6 | 82.6 | 16.1 | 71.0 | 24.1 | 68.2 | 149.1 | 71.4 |
| V1 - 2.0% | 0.0 | 100.0 | 0.0 | 100.0 | 0.0 | 100.0 | 0.0 | 100.0 |
| V6 - 0.5% | 11.6 | 43.5 | 17.0 | 69.4 | 17.0 | 77.6 | 159.4 | 69.4 |
| V6 - 2.0% | 6.3 | 69.6 | 10.7 | 80.6 | 17.9 | 76.5 | 118.3 | 77.3 |
| V9 - 0.5% | 4.5 | 78.3 | 4.5 | 91.9 | 4.5 | 94.1 | 46.9 | 91.0 |
| V9 - 2.0% | 0.0 | 100.0 | 0.0 | 100.0 | 0.0 | 100.0 | 0.0 | 100.0 |

The results of Table 25 show that compositions V1 and V9 used at 2% by mass in water are very effective on grapevine in vivo against powdery mildew of grapevine (Erysiphe necator).

1. An antifungal composition for use in the field of agriculture, containing molybdenum ions and in particular molybdate ions, the antifungal composition comprising an active ingredient comprising a combination of:
at least one compound selected from a group consisting of resveratrol, smilagenin and hecogenin;
molybdenum ions/molybdate; and
at least one ion selected from among a group consisting of iron, potassium, magnesium, copper and manganese ions.

2. The antifungal composition according to claim 1, further comprising a vehicle/solvent.

3. The antifungal composition according to claim 1 wherein said resveratrol is mostly trans-resveratrol.

4. The antifungal composition according to claim 1, wherein a mass percentage of trans-resveratrol is greater than or equal to 0.01 and/or a mass percentage of hecogenin is greater than or equal to 0.00032 and/or a mass percentage of smilagenin is greater than or equal to 0.004.

5. The antifungal composition according to claim 1 wherein it comprises trans-resveratrol, hecogenin and smilagenin and said trans-resveratrol, hecogenin and smilagenin are contained in a yucca juice.

6. The antifungal composition according to claim 5, wherein it comprises a mass percentage of yucca juice greater than or equal to 1; 2; 2.5; 3; 3.5; 4; 4.5; 5; 5.5; 6; 6.5 or 10.

7. The antifungal composition according to claim 1, wherein it comprises a mass percentage of iron greater than or equal to 0.1 and less than or equal to 4 or 5 and/or a mass percentage of copper greater than or equal to 0.1 and less than or equal to 4 or 5 and/or a mass percentage of potassium greater than or equal to 0.05 and less than or equal to 0.5 and/or a mass percentage of molybdenum greater than or equal to 0.01 and less than or equal to 0.05 and/or a mass percentage of manganese greater than or equal to 0.1 and less than or equal to 5 and/or a mass percentage of magnesium greater than or equal to 0.01 and less than or equal to 1.

8. The antifungal composition according to claim 1, further comprising at least one ingredient selected from a group consisting of humic acids, boron salts, zinc salts, acetic acid, citric acid, fructose, yeasts, iodine salts, lignosulphates, selenate salts, tungstate salts and robusta.

9. The antifungal composition according to claim 8, further comprising acetic acid, citric acid, fructose, potassium iodide, calcium lignosulphates, sodium tungstate, selenate salts, liquid coffee extract and yeast extract.

10. A sprayable antifungal composition, for use in the field of agriculture, comprising from 0.05% to 10% by mass of the composition according to claim 1, diluted in in water and in 0.05%, 0.2%, 0.4%, 0.5%, 1%, 2%, 3%, 6% or 10% by mass of the composition.

11. The sprayable composition according to claim 10 wherein it has an acidic pH, greater than or equal to 3.2.

12. A method for treating a plant particularly chosen in particular from among the plants of the following families: Brassicaceae of which rapeseed, Fabaceae of which soybean, Vitaceae of which grapevine, Poaceae of which wheat, maize, Rosaceae of which apple and pear trees, Solanaceae of which potato, tomato, aubergine Alliaceae of which onion, garlic, shallot or leeks, Apiaceae of which carrots, Asteraceae of which lettuce, artichoke, sunflower, Chenopodiaceae of which beetroot, against in particular at least one pathogen chosen from among Alternaria solani, Septoria tritici, Plasmopara viticola, Fusarium graminearum and Erysiphe necator, Pythium ultimum, Tilletia caries, Zymoseptoria tritici and Rhizoctonia solani, the method comprising applying the sprayable composition according to claim 1 on the leaves of said plant or on the seeds of said plant.

13. The antifungal composition according to claim 2, wherein said vehicle/solvent is water.

14. The antifungal composition according to claim 8, wherein said yeast is Saccharomyces cerevisiae.

15. The antifungal composition according to claim 9, wherein said selenate salts is sodium selenate and said yeast extract is Saccharomyces cerevisia.
